(19) United States
(12) Patent Application Publication
(10) Pub. No.: US 2007/0223036 A1
(43) Pub. Date: Sep. 27, 2007

(54) Medium processing apparatus with queue management function

(75) Inventor: Chun-Chieh Liao, Hsinchu City (TW)

Correspondence Address: BIRCH STEWART KOLASCH & BIRCH, PO BOX 747, FALLS CHURCH, VA, 22040-0747, US

(73) Assignee: AVISION INC.

(21) Appl. No.: 11/723,118

(22) Filed: Mar. 16, 2007

(30) Foreign Application Priority Data
Mar. 24, 2006 (TW) 095110190

(51) Int. Cl. G06K 15/00

(52) U.S. Cl. 358/1.16

(57) ABSTRACT

A medium processing apparatus with queue management function includes a queue managing unit, and a connection port, an operation interface and a medium processing unit, all of which are connected to the queue managing unit. The queue managing unit receives, through the connection port, and stores a plurality of job signals coming from a network system. The operation interface generates and outputs a control signal to the queue managing unit according to a set of control instructions inputted by a user. The queue managing unit outputs at least one of the job signals to the medium processing unit according to the control signal so that the medium processing unit performs an image processing procedure on a medium.

### BACKGROUND OF THE INVENTION

1. Field of Invention

The invention relates to a medium processing apparatus with queue management function, and more particularly to a scanner, a printer or a multi-function peripheral with queue management function.

2. Related Art

Although the developments of the scanner and the printer are getting more and more advanced, the users still have to place an original on a scan platen or a sheet-feeding mechanism of the scanner or to place a sheet on the printer so that the object of image processing (image inputting and outputting) can be achieved.

The printer may be shared using a conventional printer server. However, the conventional printer server processes jobs according to the order of the printing data. When many users want to use the printer simultaneously, no problem would occur if the specifications of the sheets are the same. However, when some user wants to print data on a special sheet (such as letter paper), he or she has to check that no unfinished job is stored in the printer server and then send out the printing file.

Alternatively, the user may pause the printing on the shared printer through the special software and then load the special sheet. After this specific printing job is finished, the user may set the shared printer to resume the printing. However, the user may forget to perform the last step, thereby bringing inconvenience to other users.

### SUMMARY OF THE INVENTION

It is therefore an object of the invention to provide a medium processing apparatus with queue management function, so that all the necessary settings for outputting an image processing job are set on a remote terminal host and the image processing job may be selected and outputted on the shared medium processing apparatus.

To achieve the above-identified object, the invention provides a medium processing apparatus with queue management function. The apparatus includes a queue managing unit and a connection port, an operation interface and a medium processing unit, all of which are connected to the queue managing unit. The queue managing unit receives a plurality of job signals coming from a network system through the connection port and stores the job signals. The operation interface receives a set of control instructions and generates and outputs a control signal to the queue managing unit. The queue managing unit outputs at least one of the job signals to the medium processing unit according to the control signal so that the medium processing unit performs an image processing procedure on a medium.

The medium processing unit may be a scanner, a printer, a fax machine or a multi-function peripheral including the scanner and the printer.

Thus, the users can set the settings of the image processing jobs on the terminal hosts and then prepare the medium processing apparatus and select the output methods without interfering with the other users' image processing jobs.

Further scope of the applicability of the present invention will become apparent from the detailed description given hereinafter. However, it should be understood that the detailed description and specific examples, while indicating the preferred embodiment of the invention, are given by way of illustration only, since various changes and modifications within the spirit and scope of the invention will become apparent to those skilled in the art from this detailed description.

### BRIEF DESCRIPTION OF THE DRAWING

The present invention will become more fully understood from the detailed description given hereinbelow and the accompanying drawing which are given by way of illustration only, and thus are not limitative of the present invention, and wherein:

FIG. 1 is a schematic illustration showing an application of a medium processing apparatus with queue management function according to a preferred embodiment of the invention.

### DETAILED DESCRIPTION OF THE INVENTION

The present invention will be apparent from the following detailed description, which proceeds with reference to the accompanying drawing, wherein the same references relate to the same elements.

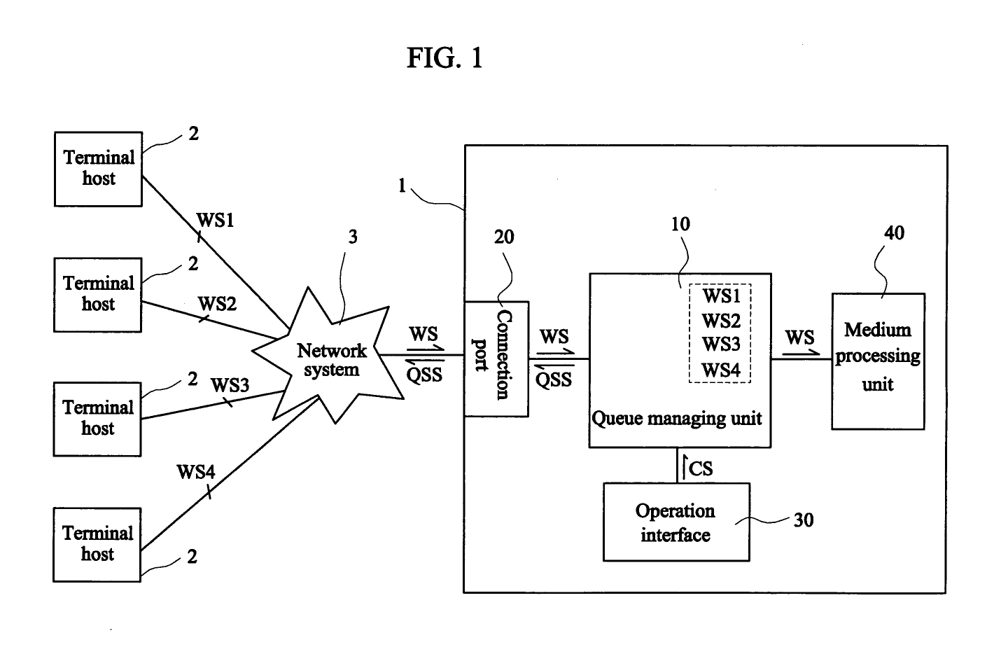

FIG. 1 is a schematic illustration showing an application of a medium processing apparatus 1 with queue management function according to a preferred embodiment of the invention. Referring to FIG. 1, the medium processing apparatus 1 with the queue management function according to the embodiment of the invention includes a queue managing unit 10, and a connection port 20, an operation interface 30 and a medium processing unit 40, all of which are connected to the queue managing unit 10.

Terminal hosts 2 may output one job signal or a plurality of job signals WS, such as WS1, WS2, WS3 and WS4, through a network system 3. The queue managing unit 10 receives the job signals WS, such as WS1, WS2, WS3 and WS4, coming from the network system 3 through the connection port 20 and stores the job signals WS. The network system 3 may be a wired network system, a wireless network system, an Internet system, an Intranet system or a phone network system. Thus, the job signals WS are generated from a computer, a mobile phone, a personal digital assistant or a domestic phone. Illustration will be made by utilizing the computers to set the job signals.

Each job signal WS may include a name, a scan resolution parameter, a scan mode parameter, a scan area parameter, a scan position parameter and an output target parameter. The users may set these parameters on the personal computers. The name may correspond to the name of the terminal host 2, or to the username registered on the terminal host 2, so the users may see which user owns the job signal WS on the medium processing apparatus 1. The scan resolution parameter corresponds to the resolution, such as 300 DPI or 200 DPI, for scanning the document. The scan mode parameter corresponds to the mode, such as the black-and-white mode, the color mode, the graphics/text mode or the gray-scale mode, for scanning the document. The scan area parameter and the scan position parameter define the position and the area of the document to be scanned. For example, the document may be an A4-sized sheet, but the user only needs to scan a lower half portion of the document. Thus, the scan area parameter and the scan position parameter may be set to define the scan area and the scan position. The output target parameter corresponds to the output method of the scanned result. For example, the scanned result may be stored in a storage device and sent to some user through e-mail, may be transmitted to a remote device on the network according to the file transmission protocol, may be transmitted back to the terminal host 2 outputting the job signal WS, or may be faxed out through the telephone line. In one example, the user may create multiple sets of e-mail accounts or fax numbers to serve as the job signals at the computer end, and then transfers the job signals to the medium processing apparatus 1. After the user is ready, he or she may press down the “Start” or “Scan” button on the medium processing apparatus 1 so that the desired tasks may be performed.

The operation interface 30 of the medium processing apparatus 1 receives a set of control instructions inputted by the user so as to generate and output a control signal CS to the queue managing unit 10. Thus, the operation interface 30 may include a set of keys, a mouse and a display or a touch panel. On the display the user may see which one of the job signals WS is being managed by the queue managing unit 10. Also, the user may select and output a single job signal or multiple job signals WS. In this case, the queue managing unit 10 outputs the job signal or the job signals WS to the medium processing unit 40 according to the control signal CS so that the medium processing unit 40 performs an image processing procedure on the medium. The medium may be an original document, a blank sheet or an overprinted sheet, and the medium processing operation includes scanning the original document or printing data on the blank or overprinted sheet of the paper.

The medium processing unit 40 may be a scanner, a printer, a fax machine or a multi-function peripheral including the scanner and the printer.

When the medium processing unit 40 is a scanner, the medium is a document, and the scanner scans an image of the document to obtain an image signal, processes the image signal and then outputs the processed image signal.

The scanner includes an output module, which may be a storage module, an e-mail sending module or a fax module, and the output target parameter includes a saving path (e.g., a directory of some computer disk or some network disk), an e-mail address or a fax number.

When the medium processing unit 40 is a printer, each job signal WS includes a name and printing data, and the printer prints the data on the medium.

When the medium processing unit 40 is a fax machine, each job signal WS includes a name and a telephone number, and the fax machine faxes out the scanned document through the telephone line or the Internet.

When the medium processing unit 40 is a multi-function peripheral, each job signal WS includes a name, a copy resolution parameter and a copy mode parameter, and the medium processing unit 40 makes copies of a document.

For the purpose of effectively managing the jobs assigned to the medium processing apparatus 1, the medium processing apparatus 1 may be configured to allow many users to log in. In this case, the set of control instructions includes a username and a password, and the queue managing unit 10 verifies the username and the password and displays on the operation interface 30 the job signal WS corresponding to the username after the username and the password are verified. In this case, the user of the low access level can only see his/her own job signal. Then, the set of control instructions further includes a selection output command, which is generated when the user uses the operation interface 30 to select certain job signal for output. The queue managing unit 10 outputs these job signals WS to the medium processing unit 40 according to the selection output command.

In order to make many remote users understand the working state of the medium processing apparatus 1 of the invention, the medium processing apparatus 1 may also be designed to have the function of displaying the queue state. In this case, when the remote user queries the queue state, the queue managing unit 10 may further output a queue state signal QSS through the connection port 20 so that the remote terminal host 2, connected to the queue managing unit 10 through the connection port 20, is notified of the queue state of the queue managing unit 10. Alternatively, the queue managing unit 10 may actively broadcast the queue state signal QSS to one single terminal host or multiple terminal hosts on the network system.

According to the medium processing apparatus of this invention, the user can complete his/her image input or image output operation without interfering with the other users' image input/output operations. Because the adjustment of the parameter settings is performed on the terminal host, the operation interface of the medium processing apparatus needs not to be too complex and the production cost needs not to be too high. In addition, because the user does not perform the scan or print operation unless he or she is ready, for example, he or she does not have to worry about that the processed medium will be taken or seen by others when and after the private medium is being processed. Thus, the invention can protect the user privacy.

While the invention has been described by way of examples and in terms of a preferred embodiment, it is to be understood that the invention is not limited thereto. To the contrary, it is intended to cover various modifications. Therefore, the scope of the appended claims should be accorded the broadest interpretation so as to encompass all such modifications.

What is claimed is:

1. A medium processing apparatus with queue management function, the apparatus comprising:
a queue managing unit; and
a connection port, an operation interface and an medium processing unit, all of which are connected to the queue managing unit, wherein:
the queue managing unit receives a plurality of job signals coming from a network system through the connection port and stores the job signals; and
the operation interface generates and outputs a control signal to the queue managing unit according to a set of inputted control instructions, and the queue managing unit outputs at least one of the job signals to the medium processing unit according to the control signal so that the medium processing unit performs an image processing procedure on a medium.

2. The apparatus according to claim 1, wherein the network system is an Internet system, an Intranet system or a phone network system.

3. The apparatus according to claim 1, wherein the network system is a wired network system or a wireless network system.

4. The apparatus according to claim 1, wherein the medium processing unit is a scanner, the medium is a document, the scanner scans an image of the document to obtain an image signal and processes the image signal for output.

5. The apparatus according to claim 4, wherein each of the job signals includes a name, a scan resolution parameter, a scan mode parameter, a scan area parameter, a scan position parameter and an output target parameter.

6. The apparatus according to claim 5, wherein the scanner comprises an output module, the output module is a storage module, an e-mail sending module or a fax module, and the output target parameter comprise a saving path, an e-mail address or a fax number.

7. The apparatus according to claim 1, wherein the medium processing unit is a printer.

8. The apparatus according to claim 7, wherein each of the job signals comprises a name and printing data, and the printer prints the printing data on the medium.

9. The apparatus according to claim 1, wherein the medium processing unit comprises a scanner and a printer.

10. The apparatus according to claim 9, wherein each of the job signals comprises a name, a copy resolution parameter and a copy mode parameter, and the medium processing unit copies the medium.

11. The apparatus according to claim 1, wherein the medium processing unit is a fax machine.

12. The apparatus according to claim 11, wherein each of the job signals comprises a name and a telephone number, the medium is a document, and the fax machine faxes the document out.

13. The apparatus according to claim 1, wherein the set of control instructions comprises a username and a password, the queue managing unit verifies the username and the password, and displays the job signals corresponding to the username on the operation interface after the username and the password are verified.

14. The apparatus according to claim 13, wherein the set of control instructions further comprises a selection output command, and the queue managing unit outputs the job signals to the medium processing unit according to the selection output command.

15. The apparatus according to claim 1, wherein the queue managing unit further outputs a queue state signal through the connection port so that a remote terminal host, connected to the queue managing unit through the connection port, is notified of a queue state of the queue managing unit.
